(19) United States
(12) Patent Application Publication
(10) Pub. No.: US 2022/0401290 A1
(43) Pub. Date: Dec. 22, 2022

(54) Muscle Tension Reliever

(71) Applicant: Charles Willmore, Austin, TX (US)

(72) Inventor: Charles Willmore, Austin, TX (US)

(21) Appl. No.: 17/350,219

(22) Filed: Jun. 17, 2021

(51) Int. Cl. A61H 15/00

(52) U.S. Cl. CPC A61H 15/00; A61H 2015/0042; A61H 2205/04; A61H 2205/081

(57) ABSTRACT

A muscle tension reliever or “self-massage tool” may include a body and a handle. The self-massage tool may include an adjustable strap and one or more associated attachment elements. The self-massage tool may include one or more massage heads and/or attachment features. A user or subject may place or secure the adjustable strap to a complementary location of the body to the massage location. The strap may be secured to a fixed attachment point or structure. The handle may be used to move the massage head as pressure is applied via the strap.

### BACKGROUND

Many individuals may suffer from tight or sore muscles, such as neck, trapezius, or upper-back muscles. Applying and maintaining pressure on sore or tight muscles can provide symptom relief. Existing solutions fail to apply sufficient pressure to such muscles to adequately relieve tension and/or soreness.

Thus, there is a need for a tool that allows individuals to perform self-massage of such muscles.

### BRIEF DESCRIPTION OF THE SEVERAL VIEWS OF THE DRAWING

The novel features of the disclosure are set forth in the appended claims. However, for purpose of explanation, several embodiments are illustrated in the following drawings.

FIG. 1 illustrates a left-side elevation view of a self-massage tool of some embodiments;

FIG. 2 illustrates a left-side elevation view of an exemplary self-massage tool of some embodiments including an adjustable strap;

FIG. 3 illustrates a top plan view of the exemplary self-massage tool of some embodiments;

FIG. 4 illustrates a front elevation view of the exemplary self-massage tool of some embodiments;

FIG. 5 illustrates a left-side elevation view of an exemplary self-massage tool body of some embodiments;

FIG. 6 illustrates a top plan view of the exemplary self-massage tool body of some embodiments;

FIG. 7 illustrates a front elevation view of the exemplary self-massage tool body of some embodiments,

FIG. 8 illustrates a front, left, top perspective view of the exemplary self-massage tool body of some embodiments;

FIG. 9 illustrates a left-side elevation view of an exemplary self-massage tool strap of some embodiments;

FIG. 10 illustrates a top plan view of the exemplary self-massage tool strap of some embodiments;

FIG. 11 illustrates a front elevation view of the exemplary self-massage tool strap of some embodiments;

FIG. 12 illustrates a front, left, top perspective view of the exemplary self-massage tool strap of some embodiments;

FIG. 13 illustrates a front, right, top perspective view of an exemplary attachment element of some embodiments; and

FIG. 14 illustrates a right-side elevation view of the exemplary attachment element of some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a muscle tension reliever or “self-massage tool”. The self-massage tool may include a body and a handle. The self-massage tool may include an adjustable strap and one or more associated attachment elements. The self-massage tool may include one or more massage heads and/or attachment features.

A user or subject may place or secure the adjustable strap to a complementary location of the body to the massage location. The strap may be secured to a fixed attachment point or structure. The handle may be used to move the massage head as pressure is applied via the strap.

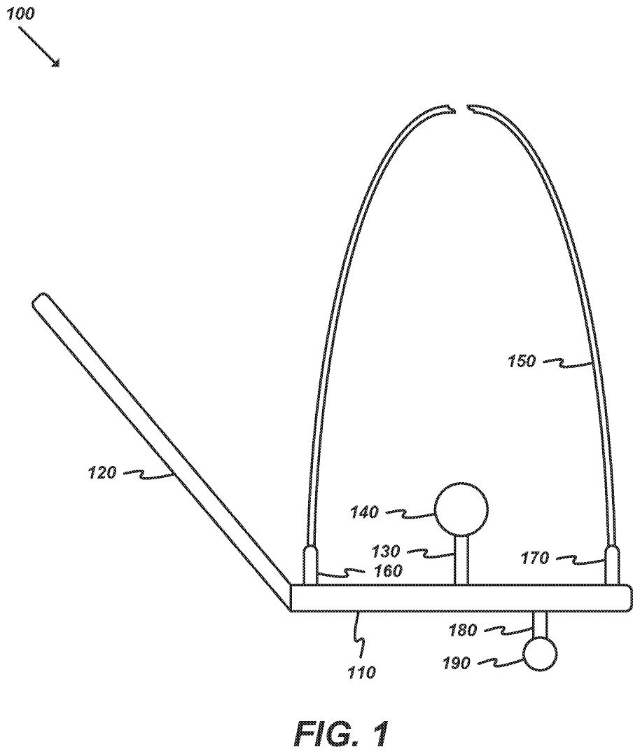

FIG. 1 illustrates a left-side elevation view of a self-massage tool 100 of some embodiments. As shown, the self-massage tool 100 may include body 110, handle 120, attachment feature 130, massage head 140, strap 150, attachment element 160, attachment element 170, attachment feature 180, and massage head 190.

Body 110 may include various rigid or partially rigid materials, such as metal, wood, fiberglass, plastic, etc. In some embodiments, body 110 may include a structural core or frame and a covering. Such a covering may include various materials, such as silicone, rubber, metal, wood, plastic, etc. In this example, the body 110 has a flat shape of a specified thickness. Different embodiments may include various differently shaped bodies, such as curved or bowed, waved, etc. Further, in this example, the body 110 may have a rectangular shape when viewed from above, but different embodiments may include various different shapes, such as oval, square, round, triangular, polygonal, etc. The size, thickness, and/or other attributes of the body 110 may be varied depending on various relevant factors, such as user size, target area, materials, etc. In some embodiments, the body 110 may be ten to twenty inches long, three to six inches wide, and one-half to one inch thick.

Body 110 may include various structural elements, such as attachment components associated with elements such as handle 120, attachment feature 130, attachment element 160, etc. Such components may include, for instance, threaded receptacles, through-holes, rods or pins, bolts or threaded posts, guides, etc.

Handle 120 (or “lever arm”) may be included as a component of body 110 (e.g., body 110 and handle 120 may be formed from a single forged, cast, or molded piece of metal or plastic), a separate element that is coupled to body 110 (e.g., by bolting handle 120 to body 110), and/or a combination thereof (e.g., a handle covering that couples to an exposed rod or pin of body 110). In this example, handle 120 has a flat rectangular shape. Different embodiments may include various differently shaped handles and/or various features associated with such handles. For instance, in some embodiments, at least a portion of handle 120 may be round or rounded. As another example, in some embodiments, handle 120 may include a hand “grip” or similar element (e.g., a rubberized cylinder, one or more knobs, etc.). Handle 120 may include various rigid or partially rigid materials, such as metal, wood, plastic. In some embodiments, handle 120 may include flexible or semi-flexible materials, such as rubber, silicone, graphite fibers and resin, flexible plastic, etc.

The size, thickness, and/or other attributes of the handle 120 may be varied depending on various relevant factors, such as user size, target area, materials, etc. In some embodiments, the handle 110 may be ten to twenty inches long, one to three inches wide, and one-half to one inch thick.

Some embodiments may include multiple handles 120, knobs, and/or other manual manipulation features. For example, some embodiments may include a rounded knob located at the opposite end (or one “distal” end) of base 110 from handle 120. In some embodiments, handle 120 may be adjustable or movable. For instance, handle 120 may include a retractable portion such that the length of the handle 120 may be adjusted. As another example, handle 120 may include multiple detachable grips of different type or size. As another example, the angle of handle 120 relative to body 110 may be adjusted across one or more pivot points.

Attachment feature 130 (also referred to as “attachment member”) may be included as a component of body 110 (e.g., body 110 and attachment feature 130 may be formed from a single piece of metal or plastic), a separate element that is coupled to body 110 (e.g., by bolting attachment feature 130 to body 110), and/or a combination thereof (e.g., an attachment feature that couples to an exposed rod or pin of body 110).

Attachment feature 130 may be associated with various massage heads 140 and/or other detachable features (e.g., a detachable base or platform, detachable support, etc.). The attachment feature 130 may include rigid or semi-rigid materials such as metal, wood, plastic, etc. In some embodiments, attachment feature 130 may include flexible or semi-flexible materials, such as rubber, silicone, graphite fibers and resin, flexible plastic, etc. Attachment feature may include various different attachment elements or components. For instance, in some embodiments, attachment feature 130 may include a threaded rod or post. As another example, attachment feature 130 may include various buttons, snaps, fasteners, etc. that may be associated with complementary features of the massage head 140 and/or other detachable features.

In some embodiments, attachment feature 130 may include “snap-together” features that allow detachable features to be attached and detached by applying force to the detachable feature relative to the attachment feature 130. For instance, attachment feature 130 may include a spherical end portion and a massage head 140 or other detachable features may include a complementary cavity or receptacle.

The size, thickness, and/or other attributes of the attachment feature 130 may be varied depending on various relevant factors, such as user preference, target area, materials, etc. In some embodiments, the attachment feature 130 may be two to six inches long with a diameter of one-quarter inch to one-half inch.

In this example, attachment feature 130 is located at or near the center of body 110, however, in different embodiments, the attachment feature 130 may be located at various positions along body 110. For instance, in some embodiments, attachment feature 130 may be offset from the center of body 110. In some embodiments, attachment feature 130 may be movable or adjustable. For instance, attachment feature 130 may be able to slide along a track or guide such that the position of the attachment feature 130 along body 110 is able to be adjusted.

Further in this example, attachment feature has a fixed height relative to body 110, however, in different embodiments, the height of attachment feature 130 may be varied. In some embodiments, the attachment feature 130 may be adjustable such that the attachment feature 130 is able to be extended away from and/or retracted toward body 110 using various adjustment features such that the height of massage head 140 (and/or other detachable features) is able to be adjusted relative to the body 110.

In this example, attachment feature 130 is shown as being perpendicular to the surface of body 110, however, in different embodiments, the attachment feature 130 may be coupled to body 110 at various different angles relative to body 110. In some embodiment, the attachment angle may be adjustable.

Different embodiments may include various different types, arrangements, and/or numbers of attachment features 130. For instance, some embodiments may include multiple attachment features 130 arranged in a pattern (e.g., a line, circle, star, etc.) along the surface of body 110. In some embodiments, a single attachment feature 130 may include multiple attachment elements such that multiple massage heads 140 (and/or other detachable features) may be able to be coupled to a single attachment feature 130.

In some embodiments, self-massage tool 100 may be associated with multiple detachable attachment features 130. For instance, attachment features 130 of various length, size, coupling type, attachment angle, etc. may be associated with a receptacle of body 110 (e.g., a threaded bore or other coupling).

Massage head 140 may include various rigid (e.g., metal, wood, plastic, etc.) and/or flexible materials (e.g., rubber, silicone, foam, etc.). Some embodiments of the massage head 140 may include a rigid or semi-rigid core or frame (e.g., a metal or plastic sphere) that may include a covering or other outer surface treatment include flexible or soft materials (e.g., a rubber, foam, or silicone cover or sleeve). The massage head 140 may include a complementary coupling to attachment feature 130. For instance, in some embodiments, massage head 140 may include a tapped bore that is complementary to a threaded post of attachment feature 130. As described above, the complementary coupling of massage head 140 (and/or other detachable features) may include various buttons, snaps, fasteners, snap-together features, and/or other elements that may be able to securely couple the detachable features to the attachment feature 130.

Different embodiments may include various different massage heads 140 and/or other detachable features. For instance, such massage heads 140 may include variously sized spheres (e.g., one-inch diameter, two-inch diameter, etc.). As another example, massage heads 140 may include various other shapes than spherical or round, such as forked or “U”-shaped, flat, spinal, conical, pneumatic tensile structures, bullet, long round, small round, shovel head, and/or other appropriate shapes. In some embodiments, a massage head 140 may include various combinations of shapes or elements (e.g., a round shape with one or more conical or pneumatic protrusion).

Strap 150 may include various flexible materials, such as leather, woven nylon and/or other fabrics (e.g., woven cotton), silicone, etc. In some embodiments, strap 150 (and/or portions thereof) may include elastic materials such as rubber, elastane, etc. Such elastic straps 150 may be associated with various levels of force or pressure (e.g., a ten-pound rubber strap, a twenty-pound rubber strap, etc.). Strap 150 may include various buckles, buttons, snaps, and/or other fasteners associated with attachment element 160 and/or attachment element 170. In some embodiments, strap 150 may include two or more portions coupled together using a buckle or other adjustable fastener.

In some embodiments, strap 150 may include various handles, grips, loops, and/or other such features that may allow a user to grasp and/or hold various locations along the strap 150. Such strap handles may be used to secure the strap to various external resources, such as hooks, pins, etc.

Attachment element 160 may include various features that may be able to be fixedly or adjustably coupled to a portion and/or feature of strap 150. Attachment element 160 may include various buckles, buttons, snaps, holes or cavities, posts, “U”-bars, “L”-bars, “D”-rings, pins, rivets, clamps, adhesives, and/or other fasteners that are complementary to associated elements of strap 150.

Attachment element 170 may be similar to attachment element 160 and/or include similar components as described above. In some embodiments, attachment element 170 may be complementary to attachment element 160 (e.g., attachment element 160 may include a fixed coupling feature while attachment element 170 includes an adjustable coupling feature). Attachment elements 160-170 may be included as components of body 110 (e.g., body 110 and attachment elements 160-170 may be formed from a single piece of metal or plastic), a separate element that is coupled to body 110 (e.g., by bolting attachment element 160 to body 110), and/or a combination thereof (e.g., an attachment element that couples to an exposed rod or pin of body 110).

In some embodiments, attachment element 160 and/or attachment element 170 may be adjustable or movable relative to body 110. For instance, attachment element 170 may be able to slide along a track or guide such that the position of the attachment element 170 along body 110 is able to be adjusted. As another example, attachment element 160 may be rotatably coupled to body 110 such that the attachment element 160 is able to spin or rotate about one or more axes.

The strap 150 length (and/or other attributes, such as attachment angle or location) may be adjustable in various ways. For instance, the strap 150 may include two or more portions adjustably coupled together via a buckle or other fastener. As another example, attachment element 170 may be fixedly coupled to strap 150, while the strap length is able to be adjusted via attachment element 160. Examples of such couplings are described in more detail below.

In some embodiments, a strap 150 may be associated with multiple sets of attachment elements 160-170. For instance, multiple fixed attachment elements 160 or 170 may be spaced along body 110 such that different angles, sizes, pressure points, etc. may be achieved by selecting among the attachment elements 160-170.

Some embodiments may include multiple straps 150 (and/or associated attachment elements) and/or straps of differing type, length, size, shape, etc. For instance, some embodiments may include a “Y”-shaped strap with three associated attachment elements. As another example, some embodiments may include two straps 150 that share a fixed attachment element 170 and have distinct adjustable attachment elements 160 (and/or vice-versa).

Attachment feature 180 (also referred to as “storage” feature) may be similar to attachment feature 130 described above. In this example, self-massage tool includes two attachment features 130 and 180 such that two detachable items, such as massage heads 140 and 190 may be able to be coupled to the self-massage tool at the same time. In this way, a user may be able to easily utilize and store different massage heads and/or other detachable features. Different embodiments may include different numbers of attachment features (e.g., three, four, six, eight, etc.), such as attachment features 130 and 180, such that any number of detachable items may be stored and/or available for use.

Massage head 190 may be similar to massage head 140 described above.

In some embodiments, attachment feature 180 may be associated with a base, platform, or other support (not shown). For instance, in some embodiments, attachment feature 180 may be associated with a complementary coupling (e.g., a threaded bore) of a square or rectangular base panel. As another example, a pole, beam, or other support may include a complementary coupling to attachment feature 180 such that self-massage tool 100 is able to be securely coupled to such a base, platform, or support to achieve desired pressure orientation with respect to various locations of the body.

During use, a user may couple the desired detachable feature, such as massage head 140, to the attachment feature 130, adjust the length of the strap 150, and/or otherwise position or configure the self-massage tool 100 for use (e.g., by coupling a base to attachment feature 180). The strap 150 may be used to control pressure applied via massage head 140 to a desired area of the body.

As one example, a round massage head 140 may be coupled to the attachment feature 130 for massaging a trapezius muscle. The user may adjust the length of strap 150 and place a portion of the strap under the opposing foot (e.g., the right foot to massage the left trapezius) when in a standing position such that downward pressure may be applied to the trapezius via massage head 140. The user may manipulate the self-massage tool 100 via handle 120 (and/or other features) such that pressure is applied to a desired location and/or variable pressure or movement may be applied. The user may further control pressure by crouching or extending, bending or straightening, leaning, etc.

As another example, the trapezius may be massaged by running a portion of the strap 150 across the user's back and securing a portion of the strap 150 under the user's opposing thigh. In some cases, the strap 150 may be coupled to only one of the attachment elements 170 while the handle 120 may be used to control pressure and movement.

As still another example, the trapezius may be massaged by grasping the strap 150 (and/or strap handle) with the opposing hand and extending that arm. The handle 120 may be used to control pressure and movement.

As yet another example, the hamstring and glute muscles may be massaged by securing the “fulcrum” strap 150 around a vertical pole, column, or other appropriate support, and/or or coupling the strap 150 (and/or a strap handle thereof) to a hook, loop, etc. A user may place one leg inside the loop formed by the strap 150 and position the massage head 140 at the desired location. The handle 120 may be used to control pressure and movement. The user may further control pressure by leaning toward, or away from, the pole or support.

As another example, the hamstring and calf muscles may be massaged by coupling the attachment feature 180 to a support plate, frame, and/or other appropriate supporting feature. Pressure may be applied via the weight of the leg to the massage head 140 located under the appropriate location. The handle 120 may be used to control pressure and movement.

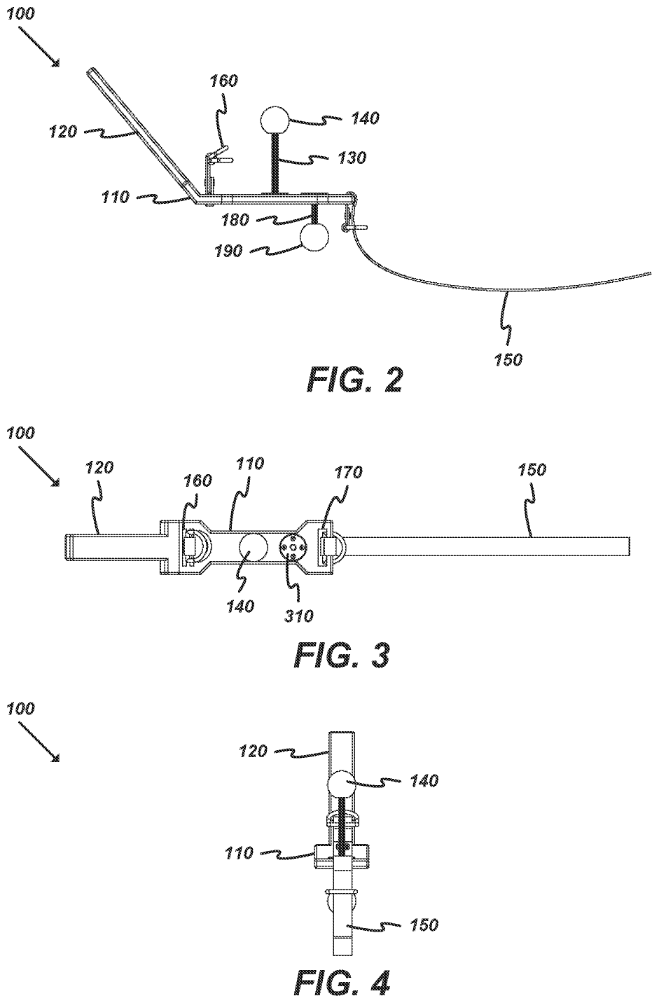

FIG. 2 illustrates a left-side elevation view of an exemplary self-massage tool 100 of some embodiments including an adjustable strap 150. FIG. 3 illustrates a top plan view of the exemplary self-massage tool 100 of some embodiments. FIG. 4 illustrates a front elevation view of the exemplary self-massage tool 100 of some embodiments.

The exemplary massage tool 100 may include a screw-on or bolt-on plate 310 with a protruding threaded receptacle that may be coupled to attachment feature 130 and attachment feature 180. Further, this example includes a fixed attachment element 170 including a rectangular hole through body 110 and an adjustable attachment element 160 including a pair of “D”-rings.

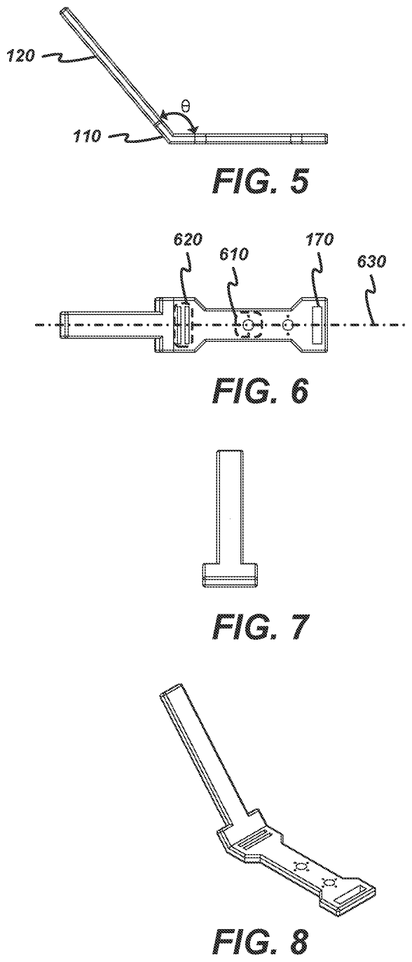

FIG. 5 illustrates a left-side elevation view of an exemplary self-massage tool body 110 of some embodiments. FIG. 6 illustrates a top plan view of the exemplary self-massage tool body 110 of some embodiments. FIG. 7 illustrates a front elevation view of the exemplary self-massage tool body 110 of some embodiments. FIG. 8 illustrates a front, left, top perspective view of the exemplary self-massage tool body 110 of some embodiments.

As shown, an angle, θ, between the body 110 and handle 120 may be an obtuse angle (e.g., between one hundred twenty and one hundred thirty-five degrees). Body 110 may include complementary attachment features 610 associated with bolt-on plate 310. Such features 610 may include various threaded holes, cavities, etc. In this example, attachment element 170 is a rectangular through-hole able to receive a portion of strap 150. In this example, connector 620 is associated with attachment element 160 and connector 620 includes two rectangular through-holes that are able to accept a portion of a strap associated with an attachment element 160 of some embodiments. The various features 610, 620, and 170 may be located along center axis 630.

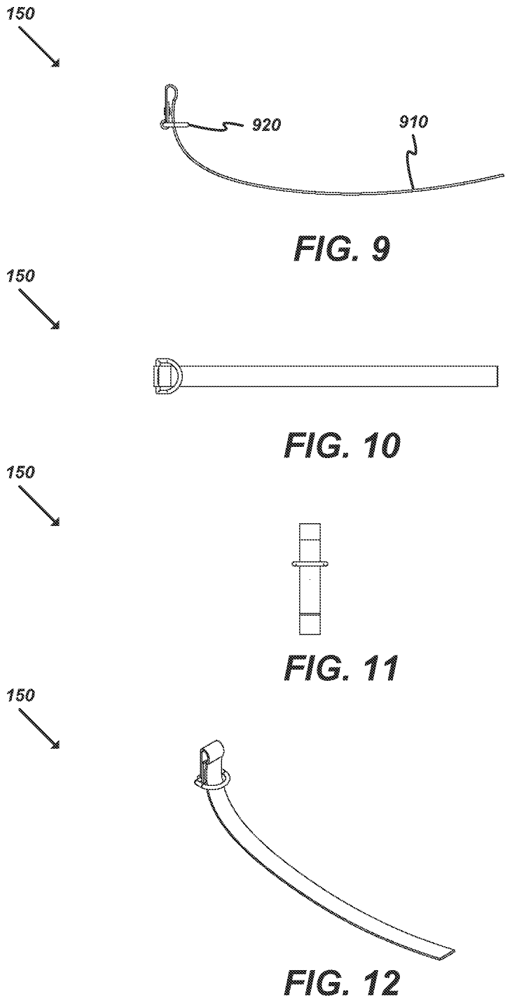

FIG. 9 illustrates a left-side elevation view of an exemplary self-massage tool strap 150 of some embodiments. FIG. 10 illustrates a top plan view of the exemplary self-massage tool strap 150 of some embodiments. FIG. 11 illustrates a front elevation view of the exemplary self-massage tool strap 150 of some embodiments. FIG. 12 illustrates a front, left, top perspective view of the exemplary self-massage tool strap 150 of some embodiments.

As shown, exemplary strap 150 may include a strap body 190 and a coupling feature 920. The strap body 190 may be flat and made from a material such as leather, nylon fabric, etc. The coupling feature 920 may include a loop or “D”-ring that is fastened to the end of strap body 190 (e.g., using a set of rivets or other fasteners). Such a strap 150 may be able to be securely fastened to an attachment element, such as attachment element 170. The other end of the strap 150 may be selectively coupled to an element such as attachment element 160, allowing the length of a loop formed by the strap 150 to be controlled.

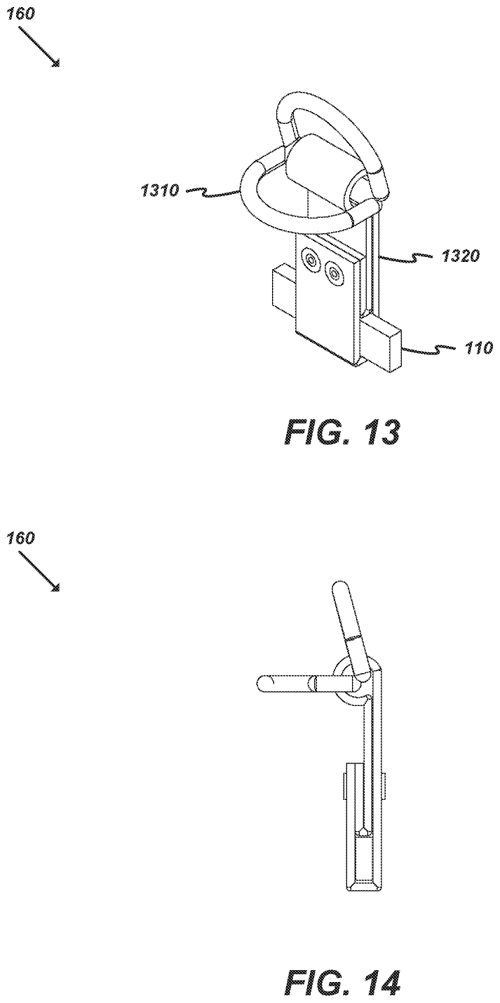

FIG. 13 illustrates a front, right, top perspective view of an exemplary attachment element 160 of some embodiments. FIG. 14 illustrates a right-side elevation view of the exemplary attachment element 160 of some embodiments.

In this example, the exemplary attachment element 160 includes a pair of “D”-rings 1310 and a strap 1320 that engages a portion of body 110 associated with connector 620. Different embodiments may include different specific elements. For instance, instead of “D”-rings 1310, some embodiments may include a buckle, clamp, or other type fastener. As another example, rather than a strap 1320, some embodiments may include a metal tube or similar element that may accept a portion of “D”-rings 1310, where the metal tube may be welded to, and/or otherwise secured to body 110.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

I claim:

1. A self-massage tool comprising:
a body;
a handle coupled to the body;
an attachment feature protruding from the body;
a fixed strap attachment element coupled to a distal end of the body; and
a strap coupled to the fixed strap attachment element.

2. The self-massage tool of claim 1 further comprising a massage head coupled to the attachment feature.

3. The self-massage tool of claim 2, wherein the massage head has a round, forked, flat, spinal, conical, pneumatic, bullet, long round, small round, or shovel head shape.

4. The self-massage tool of claim 1 further comprising an adjustable strap attachment element coupled to the body.

5. The self-massage tool of claim 4, wherein the strap couples to the adjustable strap attachment element to form an adjustable size loop including the body.

6. The self-massage tool of claim 5, wherein the adjustable strap attachment element comprises a pair of “D”-rings.

7. The self-massage tool of claim 6, wherein the fixed strap attachment element comprises a rectangular hole through the body.

8. The self-massage tool of claim 7, wherein the strap comprises a coupling feature including a “D”-ring.

9. The self-massage tool of claim 1, wherein the handle is coupled to an opposite distal end of the body.

10. The self-massage tool of claim 9, wherein the handle is coupled to the body at an obtuse angle.

11. A muscle tension reliever comprising:
a body;
an attachment feature protruding from the body;
a massage head coupled to the attachment feature; and
a fulcrum strap attached to the body.

12. The muscle tension reliever of claim 11, wherein the attachment feature comprises a post having a threaded portion.

13. The muscle tension reliever of claim 12, wherein the massage head comprises a tapped bore that is complementary to the threaded portion.

14. The muscle tension reliever of claim 11, wherein a first portion of the fulcrum strap is fixedly coupled to the body.

15. The muscle tension reliever of claim 14, wherein a second portion of the fulcrum strap is adjustably coupled to the body.

16. The muscle tension reliever of claim 11 further comprising a lever arm that extends out from a distal end of the body.

17. The muscle tension reliever of claim 16, wherein the body and the lever arm are formed from a single piece of metal or plastic.

18. The muscle tension reliever of claim 11 further comprising an alternative attachment feature protruding from the body.

19. The muscle tension reliever of claim 19, wherein the alternative attachment feature is able to be coupled to the massage head, an alternative massage head, or a support plate.

20. The muscle tension reliever of claim 11, wherein the fulcrum strap comprises at least one handle.
